(19) United States
(12) Patent Application Publication
(10) Pub. No.: US 2013/0323536 A1
(43) Pub. Date: Dec. 5, 2013

(54) RECHARGEABLE BATTERY PACK

(71) Applicants: Jong-Hwa HUR, Yongin-si (KR); Sang-Do HEO, Yongin-si (KR)

(72) Inventors: Jong-Hwa HUR, Yongin-si (KR); Sang-Do HEO, Yongin-si (KR)

(73) Assignee: Samsung SDI Co., Ltd., Yongin-si (KR)

(21) Appl. No.: 13/618,505

(22) Filed: Sep. 14, 2012

Related U.S. Application Data
(60) Provisional application No. 61/653,896, filed on May 31, 2012.

(51) Int. Cl. H01M 10/42

(52) U.S. Cl. 429/7

(57) ABSTRACT

Disclosed is a rechargeable battery pack which can reduce the number of parts and simplify the assembly process. The rechargeable battery pack includes an electrode assembly performing charging and discharging operations, a protection circuit module insulation assembly, and a case accommodating the electrode assembly and bonded to the protection circuit module insulation assembly, the protection circuit module insulation assembly further including an electrolyte injection opening formed by penetration and a sealing plug sealing the electrolyte injection opening.

### CLAIM OF PRIORITY AND CROSS-REFERENCE TO RELATED APPLICATIONS

This application claims priority under 35 U.S.C. §119(e) to U.S. Provisional Application No. 61/653,896, filed 31 May 2012, which is herein incorporated by reference in its entirety. Furthermore, the present application is related to a co-pending U.S. application, Serial No. (to be assigned), entitled RECHARGEABLE BATTERY, based upon U.S. Provisional Application No. 61/635,543, filed 19 Apr. 2012, and filed in the U.S. Patent & Trademark Office concurrently with the present application.

### BACKGROUND OF THE INVENTION

1. Field of the Invention

This disclosure relates to a rechargeable battery pack which can simplify a pack assembly process.

2. Description of the Related Art

A rechargeable battery can be repeatedly charged and discharged, unlike a primary battery, which cannot be recharged. A low-capacity rechargeable battery is used for small portable electronic devices, such as mobile phones, laptop computers, and camcorders. A large-capacity battery is used as a power source for driving motors, such as for hybrid vehicles.

A rechargeable battery pack includes a bare cell and a protection circuit module (PCM) protecting the bare cell. The protection circuit module includes a circuit board having a protection circuit to prevent the bare cell from overcharging, overdischarging, overcurrent, and short-circuiting, and protection parts mounted on the circuit board.

The protection circuit module is assembled with the bare cell by a molding portion formed of insulating resin filled between the protection circuit module and the bare cell. The bare cell includes an insulation tape surrounding an electrode assembly, a cap plate, and an insulation holder provided between the electrode assembly and the cap plate, thereby having an electrical insulation structure and a sealing structure between the electrode assembly and the protection circuit module.

Accordingly, the number of parts of the bare cell is large, and the assembly process of the bare cell and the protection circuit module becomes complicated.

The above information disclosed in this Background section is only for enhancement of understanding of the background of the described technology, and therefore it may contain information that does not form the prior art that is already known in this country to a person of ordinary skill in the art.

### SUMMARY OF THE INVENTION

The described technology has been made in an effort to provide a rechargeable battery pack which reduces the number of parts and simplifies the assembly process.

An exemplary embodiment provides a rechargeable battery pack including an electrode assembly performing charging and discharging operations, a protection circuit module insulation assembly, and a case accommodating the electrode assembly and bonded to the protection circuit module insulation assembly. The protection circuit module insulation assembly further includes an electrolyte injection opening and a sealing plug for sealing the electrolyte injection opening.

According to an exemplary embodiment, the rechargeable battery pack is manufactured by a process of inserting the electrode assembly into the case when the protection circuit module insulation assembly and the electrode assembly are connected, and bonding the protection circuit module insulation assembly to the case, thereby reducing the number of parts and simplifying the assembly process.

### BRIEF DESCRIPTION OF THE DRAWINGS

FIG. 1 is an exploded perspective view of a rechargeable battery pack according to a first exemplary embodiment of the present invention.

FIG. 2 is a perspective view of a rechargeable battery pack according to a first exemplary embodiment of the present invention.

FIG. 3 is a cross-sectional view taken along line of FIG. 2.

FIG. 4 is a cross-sectional view of the protection circuit module insulation assembly of FIG. 3.

FIG. 5 is a cross-sectional view of a protection circuit module insulation assembly of a rechargeable battery pack according to a second exemplary embodiment of the present invention.

FIG. 6 is a cross-sectional view of a protection circuit module insulation assembly of a rechargeable battery pack according to a third exemplary embodiment of the present invention.

FIG. 7 is a cross-sectional view of a protection circuit module insulation assembly of a rechargeable battery pack according to a fourth exemplary embodiment of the present invention.

FIG. 8 is a cross-sectional view of a protection circuit module insulation assembly of a rechargeable battery pack according to a fifth exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention. The drawings and description are to be regarded as illustrative in nature and not restrictive. Like reference numerals designate like elements throughout the specification.

The present invention is directed to a rechargeable battery comprising a case, an electrode assembly arranged within the case, and a protective circuit module arranged in an opening in the case to seal the electrode assembly within the case. The protective circuit module comprises a circuit board, a resin, covering at least partially a side of the circuit board, which is disposed towards the electrode assembly, an electrolyte injection opening extending through the circuit board and the resin, and a first electrode tab and a second electrode tab each connected to the circuit board. The resin may form a peripheral boundary surrounding the circuit module that mates against an interior periphery around the opening in the case, thereby forming a seal.

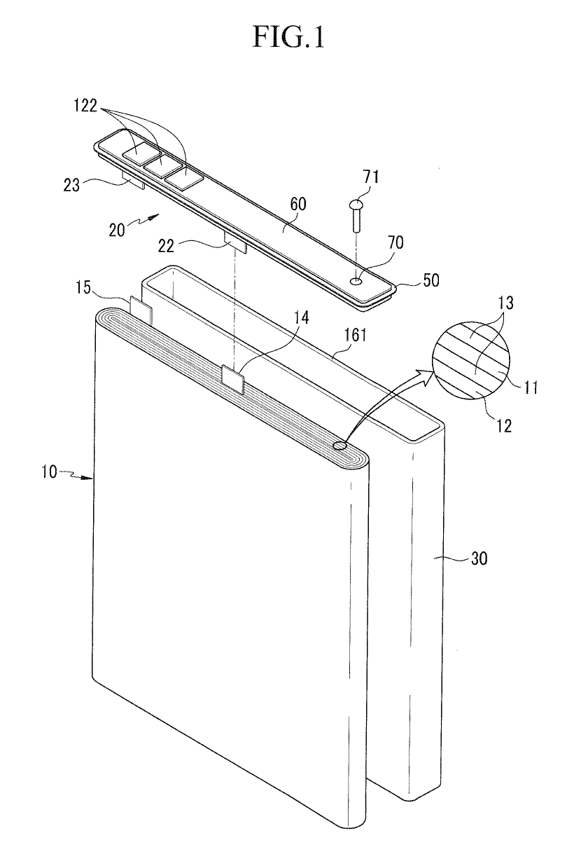

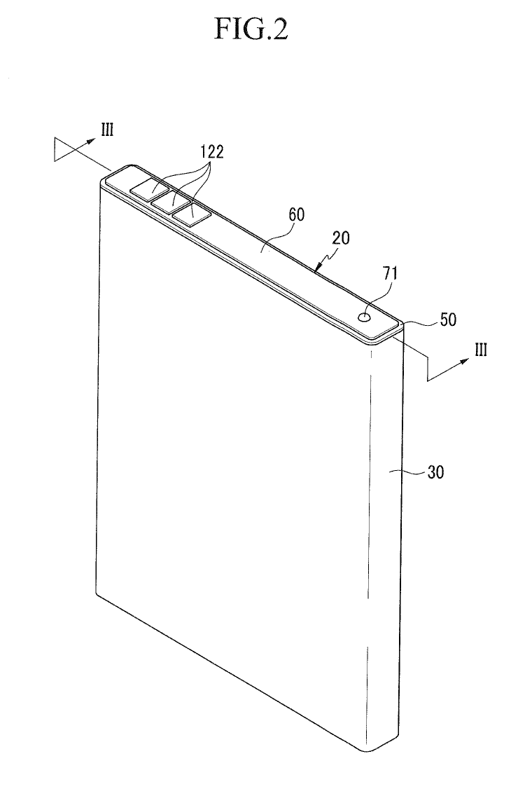

FIG. 1 is an exploded perspective view of a rechargeable battery pack according to a first exemplary embodiment of the present invention. FIG. 2 is a perspective view of a rechargeable battery pack according to a first exemplary embodiment of the present invention.

Referring to FIGS. 1 and 2, the rechargeable battery pack of the first exemplary embodiment includes an electrode assembly 10 performing charging and discharging operations, a protection circuit module insulation assembly 20, and a case 30 receiving the electrode assembly 10 and bonded to the protection circuit module insulation assembly 20.

The electrode assembly 10 is formed by stacking a first electrode (hereinafter, “positive electrode”) 11 and a second electrode (hereinafter, “negative electrode”) 12 on both sides of a separator 13 serving as an electrical insulator, with the insulator 13 interposed therebetween, and winding them in a jelly-roll shape.

The electrode assembly 10 includes a first electrode lead (hereinafter, “positive lead”) 14 connected to the positive electrode 11 and a negative lead 15 connected to the negative electrode 12, and may be electrically connected to the protection circuit module insulation assembly 20.

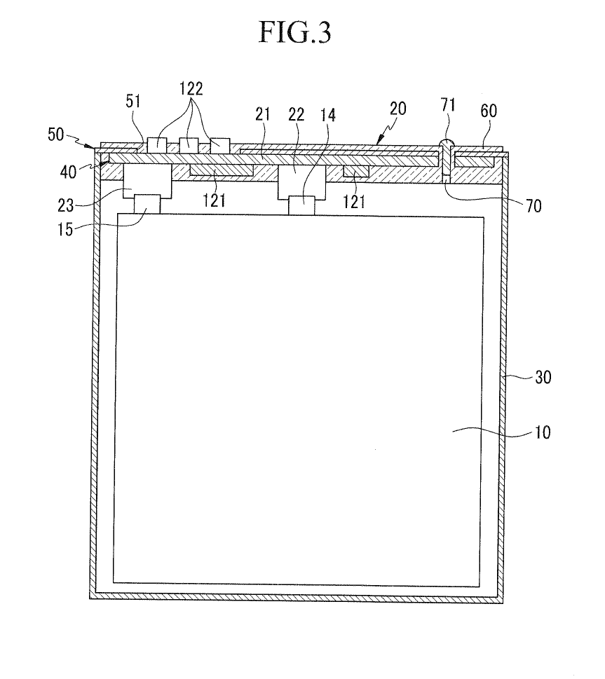

FIG. 3 is a cross-sectional view taken along line of FIG. 2. Referring to FIGS. 1 to 3, the protection circuit module insulation assembly 20 is formed integrally with a protection circuit module 40, a metal member 50, and a molding portion 60, thereby sealing an opening of the case 30.

The protection circuit module 40 includes a circuit board 21 having a protection circuit to protect the electrode assembly 10 from overcharging, overdischarging, overcurrent, and short-circuiting and a first electrode tab (hereinafter, “positive electrode tab”) 22 and a second electrode tab (hereinafter, “negative electrode tab”) 23 that are connected to the circuit board 21.

The circuit board 21 has a wiring pattern printed on the board, and the wiring pattern may be provided in a plurality of layers having an insulation structure. In an example, the circuit board 21 has a rectangular, thin, plate-like shape which longitudinally extends along the lengthwise direction so as to be inserted into the opening of the case 30, and is formed to be narrow in the widthwise direction crossing the lengthwise direction.

The positive electrode tab 22 is installed substantially near the center of a first surface (inner surface in FIG. 3) of the circuit board 21, and is electrically connected to the circuit board 21. For example, the positive electrode tab 22 is a nickel tab or an aluminum tab made of an electrically conductive material, and is welded to the positive electrode lead 14 to electrically connect the circuit board 21 and the electrode assembly 10.

The negative electrode tab 23 is installed at one end of the first surface of the circuit board 21 and electrically connected to the circuit board 21. For example, the negative electrode tab 23 is a nickel tab or an aluminum tab made of an electrically conductive material, and is welded to the negative electrode lead 15 to electrically connect the circuit board 21 and the electrode assembly 10.

The circuit board 21 includes a protection device 121 and an external terminal 122 that are mounted in a printed pattern to form a protection circuit. The protection device 121 is disposed on the first surface (inner surface) of the circuit board 21, and may consist of devices such as a control IC, a charging/discharging switch, etc. The external terminal 122 is disposed on a second surface (outer surface in FIG. 3) of the circuit board 21, and is connected to an external load to perform discharging or connected to a charger to perform charging.

That is, the first surface (inner surface) of the circuit board 21 faces the electrode assembly 10 at the inside of the protection circuit module insulation assembly 20, and the second surface (outer surface) thereof faces the outside of the protection circuit module insulation assembly 20.

The metal member 50 extends along the periphery of the protection circuit module insulation assembly 20 to protrude from the edges of the protection circuit module insulation assembly 20. A protruding part of the metal member 50 is bonded to an opening at one side of the case 30 by welding, thereby allowing the protection circuit module insulation assembly 20 to seal the opening of the case 30.

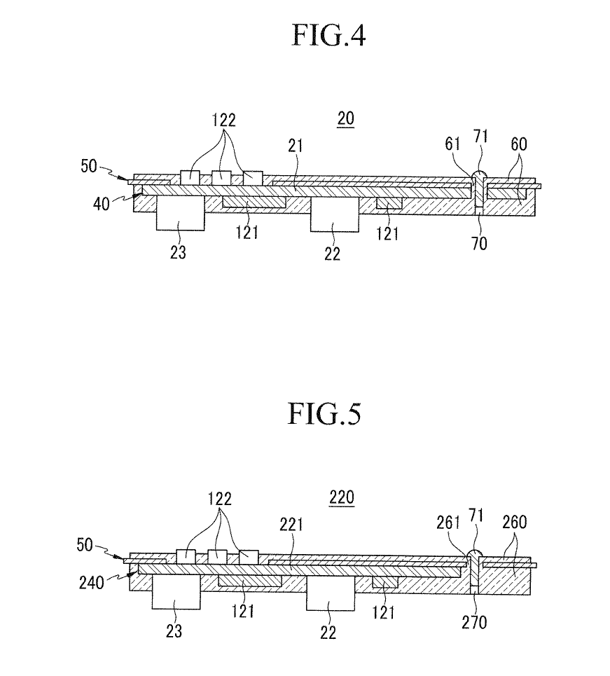

FIG. 4 is a cross-sectional view of the protection circuit module insulation assembly 20 of FIG. 3. Referring to FIGS. 3 and 4, the metal member 50 is formed in a rectangular, plate-like shape and is bonded to the top of the protection circuit module 40.

That is, the metal member 50 is bonded to the top of the circuit board 21, and further protrudes outwardly from a lateral end of the circuit board 21. Accordingly, the protection circuit module 40 and the circuit board 21 are inserted into the case 30, and the metal member 50 terminates at an edge of the opening of the case 30.

The protrusion range of the protruding part of the metal member 50 corresponds to the edge thickness of the case 30 having the opening, thereby preventing the protruding part and a welding part of the case 30 from protruding beyond a lateral surface of the case 30.

The metal member 50 and the protection circuit module 40, i.e., the metal member 50 and the circuit board 21, are electrically insulated from each other. For example, the metal member 50 and the circuit board 21 may be bonded by fusion bonding or the like, and a buffer layer (not shown) may be provided for insulation between them.

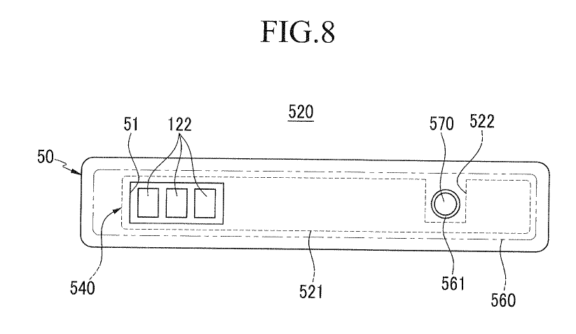

The metal member 50 has a through hole 51 (see FIGS. 3 and 8) at a location corresponding to the external terminal 12, which allows the external terminal 122 formed on the second surface (outer surface) of the circuit board 21 to protrude beyond the protection circuit module insulation assembly. As the metal member 50 is disposed on the second surface of the circuit board 21, the protection device 121 mounted on the first surface of the circuit board 21 does not interfere with the metal member 50.

The protection circuit module insulation assembly 20 is formed in an integral manner, with the bonded protection circuit module 40 and metal member 50 contained within the molding portion 60. The molding portion 60, which is formed of resin, may be formed by insert molding.

That is, the bonded protection circuit module 40 and metal member 50 are installed inside a mold and molten resin is injected into the mold, so that the molten resin surrounds the outer parts of the protection circuit module 40 and metal member 50. As the molten resin coagulates, the molding portion 60 is formed. Accordingly, the protection circuit module 40, the metal member 50, and the molding portion 60 are integrally formed.

Since the molding portion 60 covers the bonded protection circuit module 40 and metal member 50 therein in such a manner as to surround the first surface and lateral ends of the circuit board 21 and the top surface of the metal member 50, the protection device 121 and the circuit board 21 can be safely protected from the outside environment and an electrolyte filled in the case 30.

The resin may cover, at least partially, a side of the circuit board, and may be disposed towards the electrode assembly. The resin may also completely cover a side of the circuit board. Furthermore, the resin may cover, at least partially, a second side of the circuit board, or the resin may completely cover both sides of the circuit board. As mentioned above, when the resin completely covers both sides of the circuit board, the resin can protect the circuit board from both the outside environment and the electrolyte.

The positive electrode tab 22 and negative electrode tab 23 connected and installed to the first surface (inner surface) of the circuit board 21 are exposed to the underside of the molding portion 60 so as to face the electrode assembly 10, and are respectively connected to the positive electrode lead 14 and the negative electrode lead 15.

In this manner, the protection circuit module insulation assembly 20 is formed integrally with the protection circuit module 40, and hence the number of parts of the rechargeable battery pack can be reduced. The rechargeable battery pack can be manufactured by a process of inserting the electrode assembly 10 into the case 30 when the protection circuit module insulation assembly 20 and the electrode assembly 10 are connected, and bonding the protection circuit module insulation assembly 20 to the opening of the case 30. Accordingly, the assembly process of the rechargeable battery pack is simplified.

The manufacturing process of the rechargeable battery pack further includes a step of accommodating the electrode assembly 10 in the case 30 and injecting the electrolyte when the protection circuit module insulation assembly 20 is attached to the case 30. Accordingly, the protection circuit module insulation assembly 20 has an electrolyte injection opening 70 so that the electrolyte is injected into the rechargeable battery pack, i.e., the case 30.

Referring to FIGS. 3 and 4, the electrolyte injection opening 70 is formed in such a way that it penetrates the protection circuit module insulation assembly 20 and connects the inside and outside of the rechargeable battery pack.

The electrolyte injection opening 70 is sealed with a sealing plug 71 after injecting the electrolyte. For example, the electrolyte injection opening 70 may be formed by penetrating the molding portion 60, the metal member 50, the protection circuit module 40, and the molding portion 60.

The electrolyte injection opening 70 is formed by penetrating the molding portion 60 at the inside and outside of the protection circuit module insulation assembly 20, and is formed as a hole in the circuit board 21 of the protection circuit module 40 and the metal member 50. An insulating layer 61 is formed along an inner wall of the penetrating hole, and the insulating layer 61 substantially defines the electrolyte injection opening 70 at corresponding regions of the circuit board 21 and metal member 50.

For example, the insulating layer 61 may be formed by coagulating the molten resin forming the molding portion 60. That is, the insulating layer 61 allows the whole electrolyte injection opening 70 to be formed of the same material as the molding portion 60, thereby eliminating a step for insulating the penetrating hole of the circuit board 21 and the metal member 50.

The electrolyte injection opening 70 is formed by the resin that forms the molding o portion 60 forming the inside and outside of the protection circuit module insulation assembly 20, and forms the insulating layer 61 of the penetrating hole of the circuit board 21 and metal member 50. Accordingly, the sealing plug 71 may perform a sealing function while making contact with the resin, which is the same material, in the entirety of the electrolyte injection opening 70.

That is, even when the electrolyte injection opening 70 is formed by penetrating layers of different materials, i.e., when the circuit board 21, the metal member 50, and the molding portion 60 are formed of different materials, the sealing plug 71 can exhibit excellent sealing performance by preventing partial thermal deformation.

Hereinafter, various exemplary embodiments of the present invention will be illustrated. The description of the same components as the first exemplary embodiment and the above-mentioned exemplary embodiments will be omitted and only the different components will be described.

FIG. 5 is a cross-sectional view of a protection circuit module insulation assembly of a rechargeable battery pack according to a second exemplary embodiment of the present invention. Referring to FIG. 5, in the protection circuit module insulation assembly 220 of the second exemplary embodiment, the protection circuit module 240, i.e., the circuit board 221, is formed apart from the electrolyte injection opening 270. That is, the electrolyte injection opening 270 is formed in such a structure that it penetrates the protection circuit module insulation assembly 220 and connects the inside and outside of the rechargeable battery pack.

The electrolyte injection opening 270 is sealed with a sealing plug 71 after injecting the electrolyte. For example, the electrolyte injection opening 270 may be formed by penetrating the molding portion 260, the metal member 50, and the molding portion 260.

The electrolyte injection opening 270 is formed by penetrating the molding portion 260 at the inside and outside of the protection circuit module insulation assembly 220, and is formed as a hole in the metal member 50. An insulating layer 261 is formed along an inner wall of the penetrating hole, and the insulating layer 61 substantially defines the electrolyte injection opening 270 at a corresponding region of the metal member 50. The electrolyte injection opening 270 is provided at one side of the circuit board 221 of the protection circuit module 240.

In the first exemplary embodiment, the electrolyte injection opening 70 is formed by penetrating the circuit board 21 as the circuit board 21 is formed across the electrolyte injection opening 70. In contrast, in the second exemplary embodiment, the electrolyte injection opening 270 is not provided in the circuit board 221. Accordingly, the circuit board 221 and metal member 50 of the second exemplary embodiment achieves a more effective electrical insulation structure at the electrolyte injection opening 270.

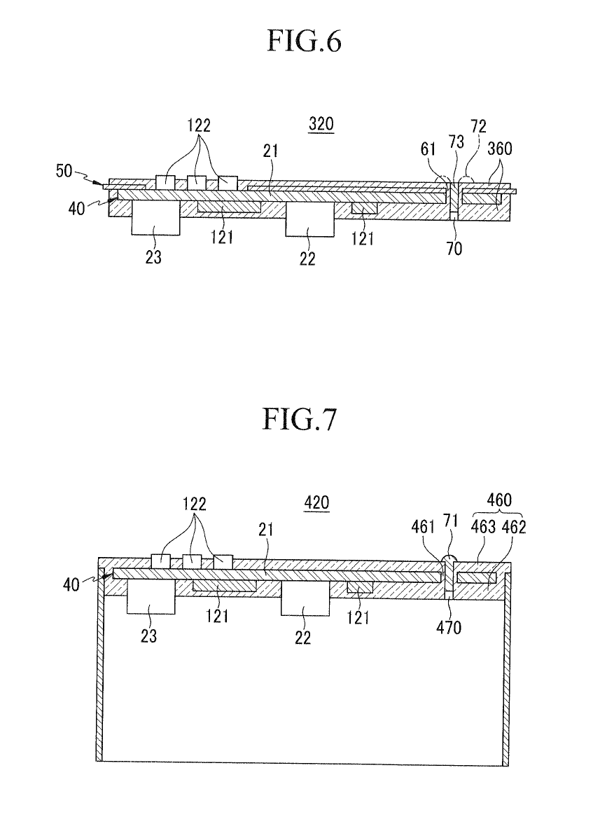

FIG. 6 is a cross-sectional view of a protection circuit module insulation assembly of a rechargeable battery pack according to a third exemplary embodiment of the present invention. Referring to FIG. 6, in the protection circuit module insulation assembly 320 of the third exemplary embodiment, the molding portion 360 has a protruding portion 72 (before electrolyte injection) formed in the vicinity of the electrolyte injection opening 70. For instance, the protruding portion 72 forms a sealing plug 73 which is thermally deformed and moved after electrolyte injection and inserted into the electrolyte injection opening 70 to seal the electrolyte injection opening 70.

That is, the sealing plug 73 formed by deforming the protruding portion 72 seals the electrolyte injection opening 70. The sealing plug 73 can have excellent sealing performance because it is formed of the same material as the insulating layer 61 and the molding portion 360. In the third exemplary embodiment, there is no need for a separate sealing plug for sealing the electrolyte injection opening 70.

In the first and second exemplary embodiments, the electrolyte injection opening 70 is sealed with a separate sealing plug 71. In contrast, in the third exemplary embodiment, the sealing plug 73 is formed by deforming the protruding portion 72 provided at the molding portion 360.

Accordingly, the sealing plug 73 formed by the protruding portion 72 of the molding portion 360 can achieve the sealing performance of the electrolyte injection opening 70 and further reduce the number of parts of the rechargeable battery pack.

FIG. 7 is a cross-sectional view of a protection circuit module insulation assembly of a rechargeable battery pack according to a fourth exemplary embodiment of the present invention. Referring to FIG. 7, the protection circuit module insulation assembly 420 of the fourth exemplary embodiment includes a protection circuit module 40 and a molding portion 460 without a metal member.

The protective circuit module of this embodiment may also exclude a metal member and any other components beyond those mentioned above. That is, the protective circuit module may optionally consist of, or consist essentially of, a circuit board, a resin, an electrolyte injection opening (with sealing plug), and a first electrode tab and a second electrode tab each connected to the circuit board.

The protection circuit module insulation assembly 420 is formed in an integral manner, with the protection circuit module 40 contained within the molding portion 460. As the molding portion 460 surrounds the first surface, second surface, and lateral ends of the circuit board 21, the protection device 121 and the circuit board 21 can be safely protected from the outside environment and the electrolyte in the case 30.

The molding portion 460 includes an insert portion 462 inserted into the case 30 and a stopping portion 463 further protruding laterally from the insert portion 462 and terminating at an edge of the opening of the case 30. When assembling the rechargeable battery pack, the electrode assembly 10 is inserted into the case 30, and then the insert portion 462 of the molding portion 460 is inserted into the opening of the case 30. At this point, the stopping portion 463 of the molding portion 460 defines a maximum insertion range of the molding portion, as it terminates at the edge of the opening of the case 30.

When assembling the protection circuit module insulation assembly 420 and the case 30, the inner surface of the case 30 and the insert portion 462 of the molding portion 460 contacting it may be bonded by thermal fusion bonding. That is, the protection circuit module insulation assembly 420 is installed to have an electrical insulation structure at the case 30, and is able to seal the opening of the case 30.

In the first to third exemplary embodiments, the metal member 50 and the case 30 are bonded by welding. In contrast, in the fourth exemplary embodiment, the molding portion 460 is bonded to the case 30 by thermal fusion bonding. In this way, the protection circuit module insulation assemblies 20, 220, 320, and 420 can be bonded to the case 30 in various methods and structures depending on their structure.

Moreover, the electrolyte injection opening 470 penetrates the protection circuit module insulation assembly 420 and connects the inside and outside of the rechargeable battery pack, and is sealed with the sealing plug 71 after electrolyte injection. For example, the electrolyte injection opening 470 may be formed by penetrating the molding portion 460 and the circuit board 21.

The electrolyte injection opening 470 is formed by penetrating the molding portion 460 at the inside and outside of the protection circuit module insulation assembly 420, and is formed as a hole in the circuit board 21. An insulating layer 461 is formed along an inner wall of the penetrating hole, and the insulating layer 461 substantially defines the electrolyte injection opening 470 at a corresponding region of the circuit board 21.

In the first exemplary embodiment, the electrolyte injection opening 70 is formed by penetrating the circuit board 21 and the metal member 50. In contrast, in the fourth exemplary embodiment, the electrolyte injection opening 470 is formed in the circuit board 21 without using a metal member. Accordingly, the circuit board 21 of the fourth exemplary embodiment achieves a more effective electrical insulation structure at the electrolyte injection opening 470.

FIG. 8 is a cross-sectional view of a protection circuit module insulation assembly of a rechargeable battery pack according to a fifth exemplary embodiment of the present invention. Referring to FIG, 8, in the protection circuit module insulation assembly 520 of the fifth exemplary embodiment, he protection circuit module 540, i.e., the circuit board 521, is formed apart from the electrolyte injection opening 570.

The electrolyte injection opening 570 is formed by penetrating the molding portion 560 at the inside and outside of the protection circuit module insulation assembly 520, and is formed as a hole in the metal member 50. An insulating layer 561 is formed along an inner wall of the penetrating hole, and the insulating layer 561 substantially defines the electrolyte injection opening 570 at a corresponding region of the metal member 50.

The circuit board 521 has a cutout portion 522 opened at one widthwise side. The cutout portion 522 makes it possible to ensure a wide effective area of the circuit board 521 while preventing interference with the circuit board 521 and the electrolyte injection opening 570. That is, the circuit board 521 of the fifth exemplary embodiment can have a wider area at one side of the electrolyte injection opening 570, as compared to the circuit board 221 of the second exemplary embodiment.

In the second exemplary embodiment, the circuit board 221 is completely removed from one side of the electrolyte injection opening 270 in the lengthwise direction. In contrast, in the fifth exemplary embodiment, the cutout portion 522 formed by removing a part of the circuit board is provided at one widthwise side of the circuit board 521. Accordingly, in the fifth exemplary embodiment, the circuit board 521 and the metal member 50 form an electrical insulation structure at the electrolyte injection opening 270, thereby widening the effective area of the circuit board 521.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
a case;
an electrode assembly arranged within the case; and
a protective circuit module arranged in an opening in the case to seal the electrode assembly within the case, the protective circuit module comprising:
a circuit board;
a resin, covering at least partially a side of the circuit board, which is disposed towards the electrode assembly;
an electrolyte injection opening extending through the circuit board and the resin; and
a first electrode tab and a second electrode tab, each connected to the circuit: board.

2. The rechargeable battery of claim 1, wherein the electrolyte injection opening further comprises an insulating layer disposed on an inner wall of the hole of the circuit board.

3. The rechargeable battery of claim 1, wherein the resin forms a peripheral boundary surrounding the circuit module that mates against an interior periphery around the opening in the case and thereby forms a seal.

4. The rechargeable battery of claim 3, wherein the resin is sealed to the case by thermal fusion bonding.

5. The rechargeable battery of claim 1, further comprising a sealing plug which seals the electrolyte injection opening.

6. The rechargeable battery of claim 1, wherein the electrolyte injection opening is formed by the resin and the resin forms an insulating layer on an inner wall of the hole of the circuit board.

7. The rechargeable battery of claim 5, wherein the sealing plug is made from the same material as the resin.
